(19) United States
(12) Patent Application Publication
(10) Pub. No.: US 2007/0024814 A1
(43) Pub. Date: Feb. 1, 2007

(54) Image projecting apparatus

(75) Inventors: Sung-je Woo, Suwon-si (KR); Byung-jo Kang, Suwon-si (KR); Won-nyun Kim, Gwacheon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/489,489

(22) Filed: Jul. 20, 2006

(30) Foreign Application Priority Data
Jul. 26, 2005 (KR) 2005-0068053

(51) Int. Cl. G03B 21/16; G03B 21/18

(52) U.S. Cl. 353/52; 353/57

(57) ABSTRACT

The present invention relates to an image projecting apparatus having a main body frame, a light generating part supported by the main body frame, and an image device forming images by using light irradiated by the light generating part. The image projecting apparatus includes a first heat absorbing part that absorbs heat generated by the image device. A second heat absorbing part absorbs heat generated by the light source. A heat dissipating part transfers heat to one of the first heat absorbing part and the second heat absorbing part. A combining part separably combines the first heat absorbing part and the second heat absorbing part to transfer heat between the first heat absorbing part and the second heat absorbing part. Thus, the present invention provides an image projecting apparatus having a modularized cooling apparatus to improve work efficiency in manufacturing and repairing the image forming apparatus.

### CROSS-REFERENCE TO RELATED APPLICATIONS

This application claims the benefit under 35 U.S.C. §119(a) of Korean Patent Application No. 2005-0068053, filed on Jul. 26, 2005, in the Korean Intellectual Property Office, the entire disclosure of which is hereby incorporated by reference.

### BACKGROUND OF THE INVENTION

1. Field of the Invention

The present invention relates to an image projecting apparatus. More particularly, the present invention relates to an image projecting apparatus having an improved cooling device.

2. Description of the Related Art

Generally, an image projecting apparatus includes an optical system having an image device and a light source supplying light to the optical system, and projects and enlarges images formed by the image device to a screen.

Recently, the trends for image projecting apparatuses has been toward smaller sizes and lighter weight, which is accompanied by several problems. Among these problems is how to dissipate the heat generated from inside of the image projecting apparatus to the outside.

The image projecting apparatus includes a plurality of heat generating units that essentially generate heat during operation. For example, the light source, such as a lamp, LED, and so forth, emits heat in addition to irradiating light. The emitted heat may cause poor functioning of circuit components in the image projecting apparatus, such as deterioration in performance, abnormal functioning, and so forth.

To avoid poor functioning of components, a conventional image projecting apparatus has adopted a plurality of cooling fans (for example, Korea first patent publication No. 2002-008902) or guiding means, such as a duct to supply outer air to each heat generating unit that requires cooling (for example, Korea patent application No. 1996-057169).

However, when a plurality of cooling fans are adopted, the cooling fans add to the overall noise generated by the image projecting apparatus. When the guiding means is adopted, the structure of the cooling system becomes relatively complicated. Utilizing both of these schemes requires an increased volume of the cooling system, so that they cannot be easily adopted in a small-sized image projecting apparatus.

Also, as the conventional image projecting apparatus includes the cooling system as one integrated body, the whole body needs to be assembled and disassembled when the image projecting apparatus is manufactured or repaired.

Accordingly, a need exists for an image forming apparatus having an improved cooling system.

### SUMMARY OF THE INVENTION

Accordingly, it is an aspect of the present invention to provide an image projecting apparatus having a modularized cooling apparatus that improves work efficiency in manufacturing and repairing the image forming apparatus.

The foregoing and other aspects of the present invention are also achieved by providing an image projecting apparatus having a main body frame, a light generating part supported by the main body frame and an image device forming images by using light irradiated by the light generating part. The image projecting apparatus includes a first heat absorbing part absorbing heat generated by the image device. A second heat absorbing part absorbs heat generated by the light source. A heat dissipating part transfers heat to one of the first heat absorbing part and the second heat absorbing part. A combining part separably combines the first heat absorbing part and the second heat absorbing part to transfer heat between the first heat absorbing part and the second heat absorbing part.

According to another exemplary embodiment of the present invention, the heat dissipating part includes a heat sink and a cooling fan to blow air to the heat sink.

According to another exemplary embodiment of the present invention, the combining part includes a heat transferring member connected between the first heat absorbing part and the second heat absorbing part, and an attaching member attaching the heat transferring member to the first heat absorbing part and the second heat absorbing part, respectively.

According to another exemplary embodiment of the present invention, the heat transferring member includes a heat pipe.

According to another exemplary embodiment of the present invention, the second heat absorbing part includes a second heat absorbing plate having an accommodating part that contacts the light generating part and accommodates the heat transferring member.

According to another exemplary embodiment of the present invention, the attaching member includes a supporting bracket attaching the heat transferring member to the second heat absorbing plate and a pressing member provided in the supporting bracket and pressing the heat transferring member toward the second heat absorbing plate.

According to another exemplary embodiment of the present invention, a plurality of second heat absorbing plates are provided. The plurality of second heat absorbing plates are connected to each other by a heat pipe.

According to another exemplary embodiment of the present invention, a plurality of heat transferring members are provided.

Other objects, advantages and salient features of the present invention will become apparent from the following detailed description, which, taken in conjunction with the annexed drawings, discloses exemplary embodiments of the present invention.

### BRIEF DESCRIPTION OF THE DRAWINGS

The above and other aspects and advantages of the present invention will become apparent and more readily appreciated from the following description of the exemplary embodiments, taken in conjunction with the accompanying drawings of which:

FIG. 1 is an exploded perspective view of the image projecting apparatus according to an exemplary embodiment of the present invention;

FIG. 2 is an enlarged perspective view of the cooling system of the image projecting apparatus of FIG. 1;

FIGS. 3 and 4 are perspective views of the image projecting apparatus illustrating the combining process of the cooling system; and

FIG. 5 is a perspective view showing a rear side of an external appearance of the image projecting apparatus of FIG. 1.

Throughout the drawings, like reference numerals will be understood to refer to like parts, components and structures.

### DETAILED DESCRIPTION OF EXEMPLARY EMBODIMENTS

Reference will now be made in detail to the exemplary embodiments of the present invention, examples of which are illustrated in the accompanying drawings.

Although the exemplary embodiments of the present invention described hereinafter are an image projecting apparatus including a Digital Micromirror Device (DMD) panel as an image device, the present invention is not limited to such an image projecting apparatus.

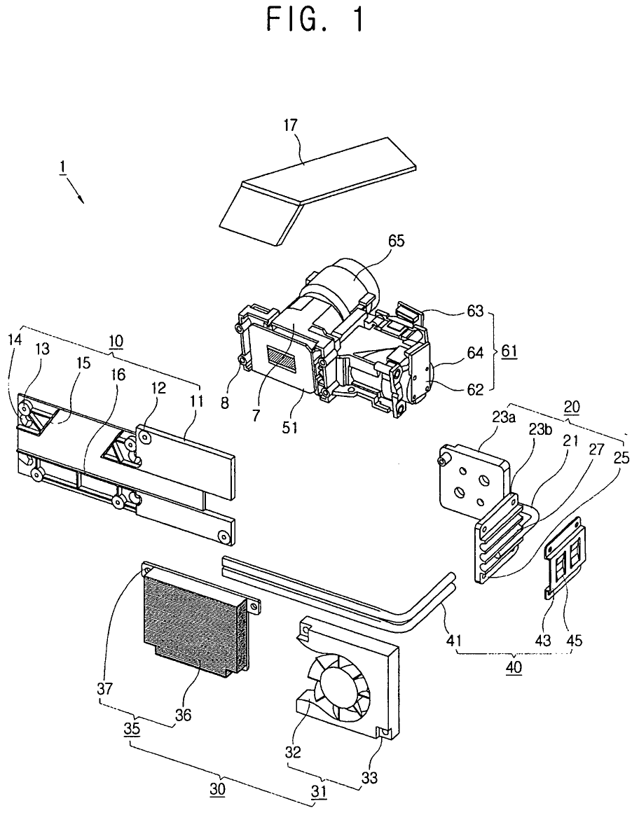

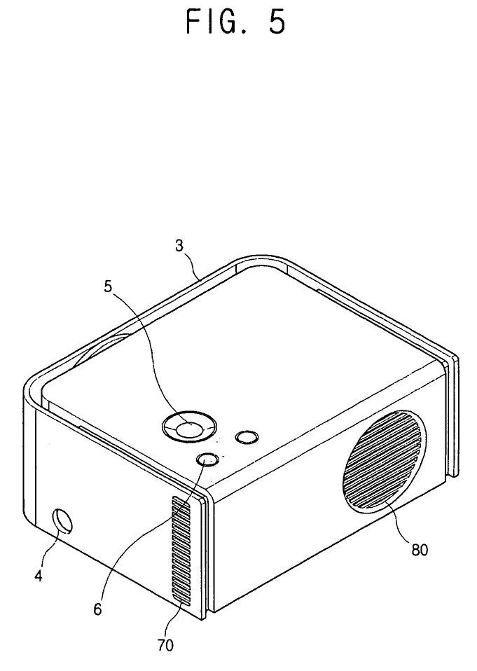

FIG. 1 is an exploded perspective view of the image projecting apparatus 1 according to an exemplary embodiment of the present invention. As shown in FIG. 1, the image projecting apparatus 1 includes a housing 3 (FIG. 5), a main body frame 7 accommodated in the housing 3, and a light generating part 61 supported by the main body frame 7. An image device 51 forms images by using light irradiated by the light generating part 61. A first heat absorbing part 10 absorbs heat generated by the image device 51. A second heat absorbing part 20 absorbs heat generated by the light generating part 61. A heat dissipating part 30 transfers heat to one of the first heat absorbing part 10 and the second heat absorbing part 20. A combining part 40 separably combines the first heat absorbing part 10 and the second heat absorbing part 20 to transfer heat between the first heat absorbing part 10 and the second heat absorbing part 20. The image projecting apparatus 1 may further include a projecting lens 65 through which the image formed by the image device 51 is projected.

The light generating part 61 includes a light source, such as an LED (Light Emitting Diode), to irradiate light and light source circuit boards 62 and 63 to drive the light source.

The light source of the light generating part 61 may be an LED (not shown). A plurality of LED's may be provided to irradiate lights having red, green and blue colors, respectively. The LED is mounted to the LED circuit boards 62 and 63. For example, the LED that irradiates green light may be mounted to the first LED circuit board 62, and the LED's that irradiate blue light and red light may be mounted to the second LED circuit board 63.

The light generating part 61 may further include a heat dissipating plate 64 provided on one side of the LED circuit boards 62 and 63 to emit the heat generated by the LED. The light generating part 61 may be provided as an arc-type discharge lamp, such as a mercury lamp, a metal halide lamp and a Xenon lamp, in place of the LED.

The image device 51 generates image signal by using the light irradiated by the light generating part 61. The image device 51 may include a DMD (Digital Micromirror Device) panel, a CRT (Cathode-Ray Tube) panel or an LCD (Liquid Crystal Display) panel.

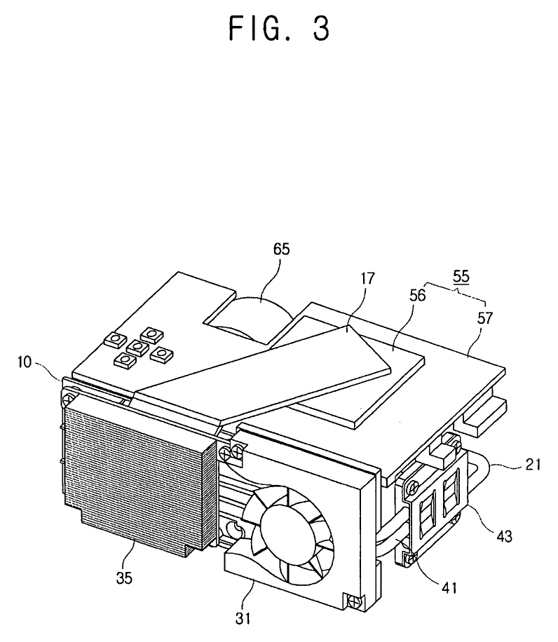

The driving part 55 is electrically connected to the image device 51 to drive the image device (FIG. 3). The driving part 55 includes a driving chip 56 and a main board 57. The driving chip 56 may be a DLP (Digital Light Processor) chip.

The first heat absorbing part 10 is conductively connected to the image device 51 to absorb heat generated by the image device 51 during operation. The first heat absorbing part 10 may include a first heat absorbing plate 11 provided to contact the image device 51, but is not limited thereto. The first heat absorbing plate 11 may contact the image device 51 or may be connected to the image device 51 through a supporting member disposed between the first heat absorbing plate 11 and the image device 51. The supporting member may be made of a material having high heat conductivity.

The size of the first heat absorbing plate 11 may be varied as needed. For example, the size of the first heat absorbing plate 11 may be provided according to the size of the image device 51. Alternatively, the size of the first heat absorbing plate 11 may be provided to extend over the whole rear side of the image projecting apparatus 1. The first heat absorbing plate 11 contacts a part of the light generating part 61 as well as the image device 51, so that the first heat absorbing plate 11 may absorb the heat generated by the light generating part 61.

The first heat absorbing plate 11 may include a main body combining part 40 combined to the main body frame 7, a heat sink combining part 37 combined to the heat sink 35, and a cooling fan combining part 33 combined to the cooling fan 31. The first heat absorbing plate 11 may further include a first guiding part 16 to accommodate a heat transferring member 41 and a second guiding part 15 to accommodate a third heat absorbing plate 17.

The third heat absorbing plate 17 has both end parts conductively connected to the driving part 55 and the first heat absorbing plate 11. The third heat absorbing plate 17 may have a multiplicity of air holes extending along its longitudinal direction on the interior (that is, in a direction from the driving part 55 to the first heat absorbing plate 11).

The second heat absorbing part 20 transfers heat from the light generating part 61 and absorbs heat generated by the light generating part 61. The second heat absorbing part 20 may include second heat absorbing plates 23a and 23b that contact the light generating part 61, but is not limited thereto. A plurality of second heat absorbing plates 23a and 23b may be provided. The second heat absorbing part 20 may further include a connecting member 21 to connect each of the second heat absorbing plates 23a and 23b. For example, the connecting member 21 may be a heat pipe. A plurality of connecting members 21 may be provided as needed.

The second heat absorbing part 20 includes an accommodating part 27 to accommodate the connecting member 21 or the heat transferring member 41. The accommodating part 27 may, for example, be provided at the second heat absorbing plate 23b. The accommodating part 27 is preferably provided corresponding to the sectional shape of the heat transferring member 41 to increase contact area between the heat transferring member 41 and the second heat absorbing plates 23a and 23b so that a large amount of heat is transferrable.

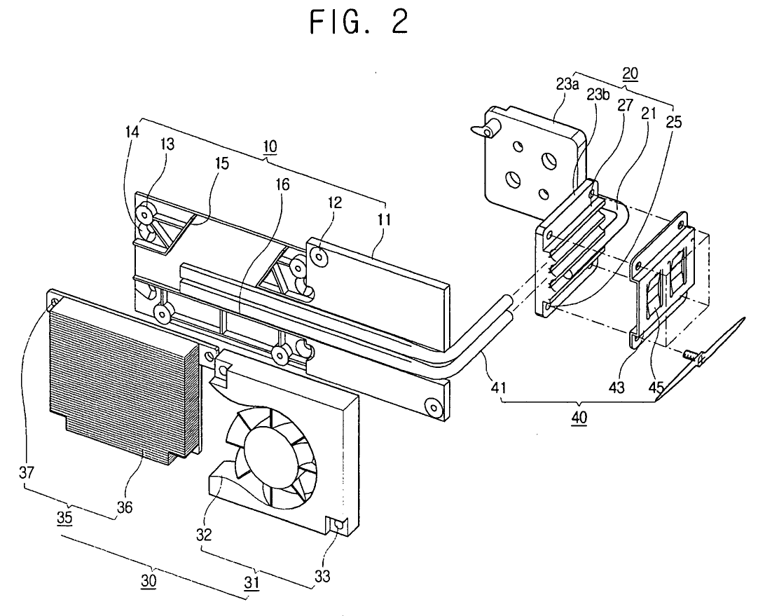

The heat dissipating part 30 is provided at a part of the main body frame 7 to transfer heat to one of the first heat absorbing part 10 and the second heat absorbing part 20. The heat dissipating part 30 may include a heat sink 35 and a cooling fan 31 blowing cooling air toward the heat sink 35. The heat dissipating part 30 collects heat generated by the light generating part 61 and the image device 51 through heat absorbing parts 10 and 20 and dissipates the collected heat to the outside. The heat dissipating part 30 may be provided not only for the first heat absorbing part 10, which is shown in FIG. 2, but also for the second heat absorbing part 20. For example, if the heat dissipating part 30 is provided for the first heat absorbing part 10, the heat generated by each heat source, which comprises the image device 51, the light generating part 61, and the driving part 55, is collected at the first heat absorbing part 10, and if the heat dissipating part 30 is provided for the second heat absorbing part 20, the heat generated by each heat source is collected by the second heat absorbing part 20.

The heat sink 35 is conductively connected to the first heat absorbing part 10 and the second heat absorbing part 20. The heat collected by the heat sink 35 is emitted to the outside by blowing of the cooling fan 31. The shape of the heat sink 35 may vary to enlarge a contact area with cooling air, thereby enhancing cooling efficiency. For example, the heat sink 35 may include cooling fins 36 having a multiplicity of protrusions on their surfaces. A heat sink combining part 37 may be provided at one side of the heat sink 35 to combine the heat sink 35 to either the first heat absorbing plate 11 or the second heat absorbing plates 23a and 23b.

The cooling fan 31 blows cooling air toward the heat sink 35 to emit the heat in the heat sink 35 to the outside. The cooling fan 31 may be disposed abreast the heat sink 35 to minimize volume required in cooling. The cooling fan 31 may include a radial flow fan (not shown) that blows cooling air in radial directions, but is not limited thereto. For example, the cooling fan 31 may include a Sirocco fan. The cooling fan 31 may have an open part 32 opened toward the heat sink 35. Also, a cooling fan combining part 33 is provided at one side of the cooling fan 31 to combine the cooling fan 31 to either the first heat absorbing plate 11 or the second heat absorbing plates 23a and 23b.

The combining part 40 separably combines the first heat absorbing part 10 and the second heat absorbing part 20 and transfers heat between the first heat absorbing part 10 and the second heat absorbing part 20. The combining part 40 may include a heat transferring member 41 connected between the first heat absorbing part 10 and the second heat absorbing part 20 and an attaching member 43 attaching the heat transferring member 41 to the first heat absorbing part 10 and the second heat absorbing part 20, respectively.

The heat transferring member 41 is provided between the first heat absorbing part 10 and the second heat absorbing part 20 to transfer heat therebetween. The heat transferring member 41 may include, for example, a heat pipe. The heat pipe may be a vacuum airtight tube. The vacuum airtight tube may have porous material on its inner wall, and the porous material may contain small amounts of saturated working fluid, such as water, ethanol, acetone, or any other suitable fluid. The working fluid absorbs heat and vaporizes at a high temperature part of the heat pipe. The vaporized working fluid is condensed and discharges heat to the outside at a low temperature part of the heat pipe. The condensed working fluid at the lower temperature part goes back to the high temperature part by a capillary pressure difference occurring at the interface of the porous material between the low temperature part and the high temperature part, thereby completing the circulation of the cooling cycle.

A plurality of heat transferring members 41 may be provided. For example, the heat transferring member 41 may be provided with two members, as shown in FIG. 2, three members, or more. One end part of the heat transferring member 41 is accommodated in the first guiding part 16 of the first heat absorbing plate 11. The other end of the heat transferring member 41 is accommodated in the accommodating part 27 of the second heat absorbing plates 23a and 23b.

The attaching member 43 attaches the heat transferring member 41 to the first heat absorbing part 10 and the second heat absorbing part 20, respectively. The attaching member 43 may attach the heat transferring member 41 to the first heat absorbing part 10 and the second heat absorbing part 20 by various attaching methods. For example, a part of the heat transferring member 41 corresponding to the first heat absorbing part 10 may be welded or bonded by adhesive, and a part of the heat transferring member 41 corresponding to the second heat absorbing part 20 may be provided with a supporting bracket 43 to fix the heat transferring member 41 to the second heat absorbing plates 23a and 23b.

The supporting bracket 43 is provided to attach the heat transferring member 41 to the second heat absorbing plates 23a and 23b. The supporting bracket 43 may have a shape of a plate, but is not limited thereto.

The pressing member 45 is provided at the supporting bracket 43 and presses the heat transferring member 41 toward the second heat absorbing plates 23a and 23b. For example, the pressing member 45 may be, but is not limited to, a plate spring, as shown in FIG. 2, which is formed at a part of the supporting bracket 43 and exerts elastic pressure toward the second heat absorbing plates 23a and 23b. The pressing member 45 may be a coil spring or a sponge provided between the heat transferring member 41 and the supporting bracket 43. Because the heat transferring member 41 is pressed to the second heat absorbing plates 23a and 23b, the pressing member 45 expands to the contact area between the heat transferring member 41 and the second heat absorbing plates 23a and 23b, so that a large amount of heat may be transferred.

As shown in FIG. 5, the housing 3 of the image projecting apparatus 1 may be provided with an intake part 80 to supply outer air to the cooling fan 31, and an exhaust part 70 to discharge hot air by the heat sink 35 to the outside. For example, as shown in FIG. 5, the intake part 80 may be provided at a part of the housing 3 corresponding to the position of the cooling fan 31 so that the inflowing air directly leads to the cooling fan 31. Also, the exhaust part 70 may be provided near the heat sink 35 so that the cooling air generated by the cooling fan 31 may directly move via the heat sink 35 to the outside (as shown in FIG. 5). The housing 3 may be provided with a cable hole 4 to insert a power cable therethrough, a power switch 5 to turn on and off the image projecting apparatus 1, and function buttons 6 to operate the image projecting apparatus 1.

Referring to FIGS. 2 to 4, the following describes the processes of assembling and dissembling the cooling system in the image projecting apparatus having components as described above.

First, as shown in FIG. 2, the heat transferring member 41 is attached to the first guiding part 16 that is provided on the first heat absorbing plate 11. Then, the heat sink 35 and the cooling fan 31 are combined to the first heat absorbing plate 11. The open part 32 of the cooling fan 31 preferably faces the heat sink 35. The third heat absorbing plate 17 may be added to absorb heat from the driving part 55.

Then, the first heat absorbing part 10 combined to the heat dissipating part 30 is also combined to the rear side of the main body frame 7, that is, to the image device 51 (as shown in FIG. 3). Accordingly, the heat generated by the image device 51 may be directly absorbed by the first heat absorbing plate 11. The absorbed heat is emitted to the outside through the heat sink 35, which is combined to the first heat absorbing plate 11.

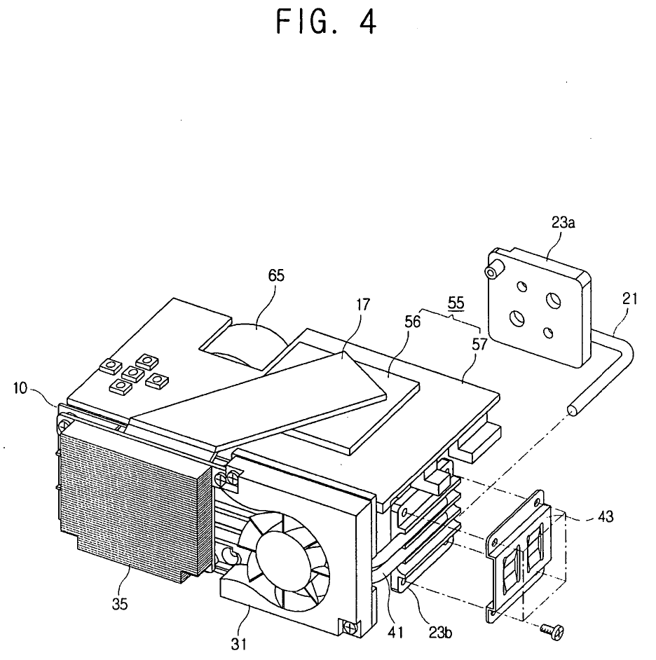

Last, the second heat absorbing part 20 is combined to a side part and a front part of the main body frame 7 to contact the light generating part 61 (shown in FIG. 4). The heat transferring member 41 combined to the first heat absorbing plate 11 is preferably accommodated in the accommodating part 27 provided on the second heat absorbing plates 23a and 23b, so that heat may be transferred between the first heat absorbing part 10 and the second heat absorbing part 20. Accordingly, the heat generated by the light generating part 61 may be absorbed by the second heat absorbing plates 23a and 23b, transferred to the first heat absorbing plate 11 through the heat transferring member 41, and emitted to the outside through the heat sink 35. The heat transferring member 41 that is connected to the first heat absorbing plate 11 is fixed to the second heat absorbing plates 23a and 23b by the supporting bracket 43. The pressing member 45 provided at the supporting bracket 43 presses the second heat absorbing plates 23a and 23b, so that the contact area between the heat transferring member 41 and the second heat absorbing plates 23a and 23b is increased to enhance the heat transfer efficiency.

The cooling system of the image projecting apparatus described above is divided into the first heat absorbing part 10 and the second heat absorbing part 20 in assembling and dissembling. Therefore, when the image projecting apparatus 1 is assembled, the first heat absorbing part 10 and the second heat absorbing part 20 are previously assembled and then integrally combined to the main body frame 7, thereby enhancing the efficiency in assembling.

Also, when the image projecting apparatus 1 is disassembled, the whole parts may not necessarily be disassembled, thus allowing repairs to be performed more easily.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. An image projecting apparatus, comprising:
a main body frame;
a light generating part supported by the main body frame;
an image device forming images by using light irradiated by the light generating part;a first heat absorbing part absorbing heat generated by the image device;
a second heat absorbing part absorbing heat generated by the light generating part;
a heat dissipating part provided to transfer heat to one of the first heat absorbing part and the second heat absorbing part; and
a combining part separably combining the first heat absorbing part and the second heat absorbing part to transfer heat between the first heat absorbing part and the second heat absorbing part.

2. The image projecting apparatus according to claim 1, wherein the heat dissipating part includes
a heat sink and/or a cooling fan to blow air to the heat sink.

3. The image projecting apparatus according to claim 2, wherein the combining part includes
a heat transferring member connected between the first heat absorbing part and the second heat absorbing part; and
an attaching member attaching the heat transferring member to the first heat absorbing part and the second heat absorbing part, respectively.

4. The image projecting apparatus according to claim 3, wherein
the heat transferring member includes a heat pipe.

5. The image projecting apparatus according to claim 3, wherein
the second heat absorbing part has a second heat absorbing plate having an accommodating part that contacts the light generating part and accommodates the heat transferring member.

6. The image projecting apparatus according to claim 5, wherein the attaching member includes
a supporting bracket attaching the heat transferring member to the second heat absorbing plate; and
a pressing member provided in the supporting bracket and pressing the heat transferring member toward the second heat absorbing plate.

7. The image projecting apparatus according to claim 5, wherein
the second heat absorbing plate is a plurality of plates connected to each other by a heat pipe.

8. The image projecting apparatus according to claim 3, wherein
the heat transferring member is provided as a plurality.

9. The image projecting apparatus according to claim 1, wherein the combining part includes
a heat transferring member connected to the first heat absorbing part and the second heat absorbing part; and
an attaching member attaching the heat transferring member to the first heat absorbing part and the second heat absorbing part, respectively.

10. The image projecting apparatus according to claim 9, wherein
the heat transferring member includes a heat pipe.

11. The image projecting apparatus according to claim 9, wherein
the second heat absorbing part includes a second heat absorbing plate having an accommodating part that contacts the light generating part and accommodates the heat transferring member.

12. The image projecting apparatus according to claim 11, wherein the attaching member includes
a supporting bracket attaching the heat transferring member to the second heat absorbing plate; and
a pressing member provided in the supporting bracket and pressing the heat transferring member toward the second heat absorbing plate.

13. The image projecting apparatus according to claim 11, wherein
the second heat absorbing plate is a plurality of plates connected to each other by a heat pipe.

14. The image projecting apparatus according to claim 9, wherein the heat transferring member is provided as a plurality.

15. The image projecting apparatus according to claim 2, wherein
an exhaust is disposed proximal the heat sink to vent air from the heat sink.

16. The image projecting apparatus according to claim 2, wherein
an intake is disposed proximal the cooling fan to supply air to the cooling fan.

17. The image projecting apparatus according to claim 2, wherein
a portion of the cooling fan proximal the heat sink is open.

18. The image projecting apparatus according to claim 4, wherein
the heat pipe is a vacuum airtight tube.

19. The image projecting apparatus according to claim 18, wherein
an inner wall of the vacuum airtight tube has a fluid to facilitate cooling of the image projecting apparatus.

20. The image projecting apparatus according to claim 6, wherein
the pressing member is a plate spring.
